(19) United States
(12) Patent Application Publication
(10) Pub. No.: US 2002/0143818 A1
(43) Pub. Date: Oct. 3, 2002

(54) System for generating a structured document

(76) Inventors: Elizabeth A. Roberts, Boise, ID (US); Terry R. Gibson Jr., Boise, ID (US); Gregory Thayer, Eagle, ID (US)

Correspondence Address: HEWLETT-PACKARD COMPANY, Intellectual Property Administration, P.O. Box 272400, Fort Collins, CO, 80527-2400, US

(21) Appl. No.: 09/820,902

(22) Filed: Mar. 30, 2001

(51) Int. Cl. G06F 17/24

(52) U.S. Cl. 707/513; 707/517

(57) ABSTRACT

A system for quickly and easily creating a structured document is disclosed. A structured document may be configured to be a document adhering to a set of pre-defined rules providing order to the content of the document. By providing sets of rules, a limited set of structured document templates may be provided while still retaining flexibility of creation for the user. A Document Type Definition (“DTD”) may be configured to provide this set of pre-defined rules for a selected template. The Document Authoring System (“DAS”) may be configured to receive a user selection of a template, the template selection being based on the type of structured document the user intends to generate. The DAS, in response to a selected template, presents the user with a graphical user interface with which to quickly and easily enter information. The user may add information and modify the structure of the template in a creative manner while the DAS limits those modifications to the boundaries defined by the DTD. Once the user has completed the modifications of the template, the DAS may utilize the modified template to generate an Output Structured Document (“OSD”) and the DAS may store this OSD in a user specified location.

### FIELD OF THE INVENTION

This invention relates generally to a computer-created structured document. In particular, the present invention relates to improving the creation of the structured document.

### DESCRIPTION OF RELATED ART

The Internet is a public, cooperative, and self-sustaining network that is accessible to hundreds of millions of people worldwide. A widely used part of the Internet is the World Wide Web (often abbreviated “WWW” or called “the Web”) in which information is referenced and displayed by electronic documents called Web pages.

With the proliferation of the Internet, providing Web pages (or documents) has become the preferred method of conveying information. For example, a business may provide Web pages including product information, troubleshooting tips, and other information with the full knowledge that a target audience may quickly and easily access those Web pages.

A business may prefer to produce Web pages as soon as possible to keep customers informed. Additionally, the business may prefer a selected format for the Web pages. However, creating Web pages may be a time intensive task. For example, in creating Web pages, a Web page author should preferably be familiar with a mark-up code language (e.g., SGML, HTML, XML, etc.). The mark-up code language comprises sets of code words (element, tag, etc.) that are typically inserted in a text file intended for display on a Web browser. The Web browser (e.g., NAVIGATOR from the Netscape Corporation of Mountain View, Calif., USA, INTERNET EXPLORER from the Microsoft Corporation of Redmond, Wash., USA, etc.) is an application program that provides a way to look at, and interact with, all of the information on the WWW. The mark-up codes provide formatting information for the Web browser to display objects (words, paragraphs, graphics) presented in the Web page, however, the mark-up codes are, typically, not made visible.

Accordingly, a Web page is typically created by inserting tags in appropriate places in a text file. However, this method of creating Web pages may be predicated on the Web page author knowing the syntax of a mark-up code language. There may be a large time commitment involved in learning a mark-up code language, thereby reducing productivity and increasing the investment cost for the Web page author.

Moreover, using a conventional text editor to author and/or edit a Web page during drafting may be difficult. For example, a Web page may be a very complicated combination of text, links, and mark-up codes, which may be difficult to read as a text file. As a result, this slows the creation of Web pages, especially if the Web page author is relatively inexperienced.

Moreover, despite a business' preference that each Web page conform to a selected format (or structure), Web pages are often produced in a non-conforming format. To maintain consistency, a great deal of training may be invested into authors to teach how to create consistent Web pages conforming to a uniform format (or structured documents). Furthermore, a staff may be created and/or retained to verify that the produced structured documents comply with the selected format. As a result, the process of creating a structured document may be slow, because several people may work on a given structured document. As a result, the process may be expensive due to the costs associated with extensive training multiple authors combined with possible employee turnover. In an effort to address these problems, conventional structured document authoring tools were developed.

FIG. 9 illustrates a block diagram 900 of a conventional authoring tool with a template 910 with a corresponding structured document 915. As shown in FIG. 9, the conventional template 910, representing a format of the structured document 915, may be configured to display a pre-determined order of document elements. The document elements may include a title box 920, a body box 930, a list box 940, and a graphic box 950. The title box 920 may receive user added information and may be utilized to generate a corresponding title 925 for the structured document 915. The body box 930 may receive user added information and may be utilized to generate a corresponding body 935 of the structured document 915. The list box 940 may receive user added information and may be utilized to generate a corresponding list 945 of the structured document 915. The graphic box 950 may receive a user added universal naming convention (“UNC”) location information for a graphical image and may be utilized to generate a corresponding graphic 955 for the structured document 915.

The number and/or order of document elements in the conventional template 910 represent a pre-defined document structure that may not be edited by a user. The template 910 may not be configured to provide the user with the capability of adding/removing document elements or modifying the document element order. The template 910 may be configured to generate an output document having a structure corresponding to the pre-determined document structure.

While the conventional template format does help maintain compliance, the conventional template may be so inflexible that a different template may be generated for each type of document. Accordingly, a conventional authoring tool may require a high setup cost to generate a large number of templates and storage disks for a large database of templates. Conventional document authoring systems may incur high maintenance costs in modification of templates for a company-wide change (e.g., a merger) and a staff to generate additional new templates for each new type of document.

### SUMMARY OF THE INVENTION

In accordance with the principles of the present invention, a method of generating a structured document includes generating an edit interface in response to a selection of a structured document template (“SDT”) from a plurality of SDTs and displaying the edit interface and a plurality of document elements associated with the edit interface. The method further includes modifying the edit interface by dragging and dropping a selected document element of the plurality of document elements and generating an output structured document (“OSD”) from the edit interface in response to a generation command.

One aspect of the present invention is a document authoring system. The document authoring system includes an edit interface generator configured to generate an edit interface in response to receiving a SDT and a user interface editor (“UIE”) configured to receive the edit interface from the edit interface generator. The UIE is further configured to modify the edit interface by dragging and dropping a selected document element and is configured to modify the edit interface by entering user-input modification data. The UIE is further configured to generate a modified edit interface in response to receiving the selected document element and the user-input modification data. The document authoring system further includes an output structured document generator (“OSDG”) configured to receive the modified edit interface. The OSDG is further configured to generate a structured document based on the modified edit interface and to output the structured document. The output may including one of printing the structured document, storing the structured document to a local directory and/or remote directory, and storing the structured document to a document management service.

Another aspect of the present invention is a program, storage device or signals readable by a computer and/or tangibly embodying instructions executable by the computer, to perform a method for generating a structured document. The instructions include enabling a user to generate a structured document capable of being printed, stored to a local directory and/or a remote directory, and/or stored to a document management service. The instructions further include generating an edit interface in response to a selection of a SDT from a plurality of SDTs and displaying the edit interface with a plurality of associated document elements. The instructions include modifying the edit interface by dragging and dropping a selected document element of the plurality of document elements and generating an OSD from the edit interface in response to a generation command.

Another aspect of the present invention is a method for generating an edit interface. The method includes generating a DTD memory model based on document elements parsed from a corresponding document type definition (“DTD”) and generating an edit interface memory model based on the DTD memory model. The method further includes embedding the DTD within the edit interface memory model, where an OSD generated from the user interface memory model is configured to be edited and outputting an edit interface based on the edit interface memory model.

Another aspect of the present invention is a method for generating an edit user interface that includes parsing a DTD memory model for a plurality of required document elements, a plurality of optional elements, and a plurality of element tags. The method also includes displaying the plurality of required document elements, each required document element being displayed as a corresponding document element dialog box in the edit interface. The method further includes displaying the plurality of optional document elements, each optional document element being displayed as a corresponding document element icon in the edit interface. The method further includes displaying the plurality of element tags, each element tag being displayed as a corresponding element tag icon in the edit interface.

Additional advantages and novel features of the invention will be set forth in part in the description which follows and in part will become apparent to those skilled in the art upon examination of the following or may be learned by practice of the invention. The advantages of the present invention may be realized and attained by means of instrumentalities and combinations particularly pointed out in the appended claims.

### DESCRIPTION OF DRAWINGS

Features and advantages of the present invention will become apparent to those skilled in the art from the following description with reference to the drawings, in which:

FIG. 1 illustrates a block diagram of an exemplary computer system in which an embodiment of the present invention may be implemented;

FIG. 2 illustrates a block diagram of an exemplary computer network 200 in which an embodiment of the present invention may be implemented;

FIG. 3 illustrates a block diagram of an exemplary embodiment of a software architecture 300 of the DAS 130, as shown in FIG. 1;

FIG. 4 illustrates an exemplary screen shot of an embodiment of an edit user interface of the UIE 350, as shown in FIG. 3;

FIG. 5 illustrates a flow diagram of an exemplary method 500 for implementing the principles of the software architecture 300, as shown in FIG. 3;

FIG. 6 illustrates a flow diagram of an exemplary method 600 for implementing the principles of the software architecture of the EIG 330, as shown in FIG. 3;

FIG. 7 illustrates a flow diagram of an exemplary method 700 for implementing the principles of the software architecture of the UIE 350, as shown in FIG. 3;

FIG. 8 illustrates a flowchart of an exemplary method 800 for implementing the principles of the software architecture of the OSDG 360, as shown in FIG. 3; and

FIG. 9 illustrates a block diagram of a conventional authoring tool.

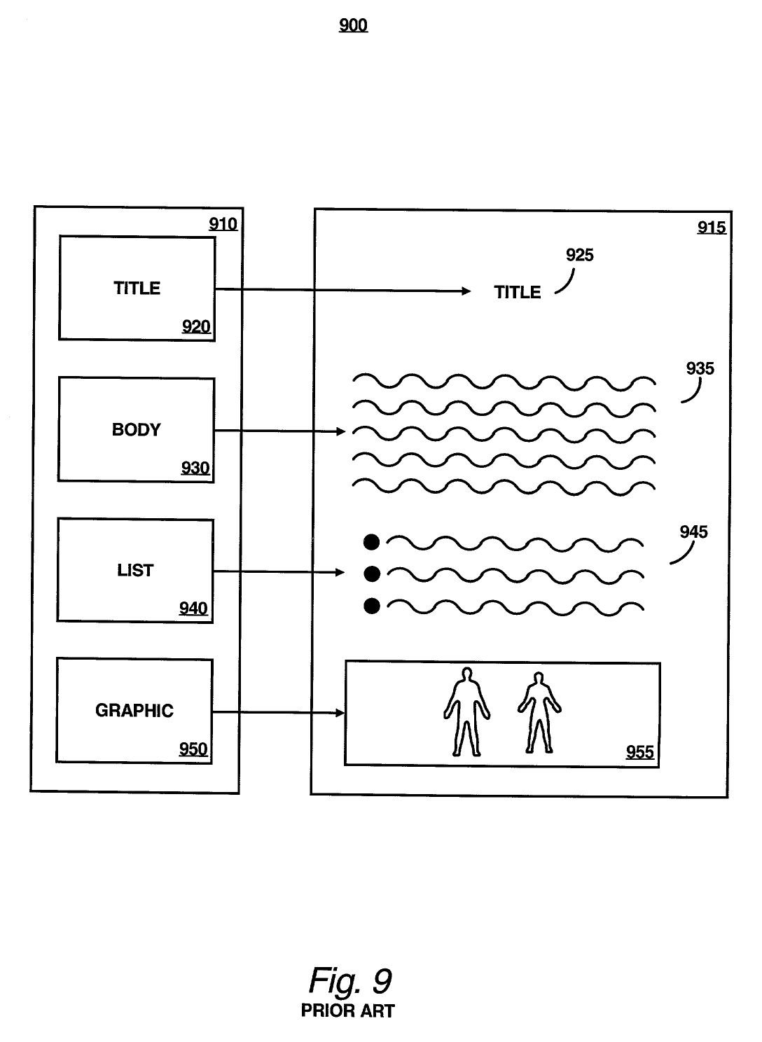

### DETAILED DESCRIPTION OF PEFERRED EMBODIMENTS

For simplicity and illustrative purposes, the principles of the present invention are described by referring mainly to an exemplary embodiment thereof. Although the preferred embodiment of the invention may be practiced as an XML authoring tool, one of ordinary skill in the art will readily recognize that the same principles are equally applicable to, and can be implemented in, any type of mark-up language authoring tool, and that any such variation would be within such modifications that do not depart from the true spirit and scope of the present invention.

In accordance with the principles of the present invention, a document authoring system (“DAS”) is utilized to quickly and easily generate a structured document by a user. In particular, the DAS may be presented to the user within a Web browser executing on a computer system. The user may initiate generation of an OSD by selecting a template from a template selector of the DAS. The template selector may be configured to provide a plurality of SDTs for the user to select a SDT. The selected SDT may then be forwarded to an edit interface generator (“EIG”) of the DAS. The selected SDT may include an embedded DTD, which may be utilized by the EIG to generate a DTD memory model.

The DTD memory model may contain a plurality of document elements. A document element may be defined as a component of the DTD. The document element may include, (e.g., title, address, author's name, etc.) as well as inter-related groups of components, (e.g., bullet lists, questions and answers, book chapters, book layouts, etc.). Accordingly, the DTD may be construed as a hierarchy of document elements. A base document element may demarcate the beginning of the DTD and an end of file (“EOF”) statement may demarcate the end of the DTD. Between the base document element and the EOF, there may be chapter or section document elements to demarcate sections. Document sections may, in turn, be comprised of document subsections, elements which further subdivide the document subsections.

The plurality of document elements of the DTD memory model may further contain a plurality of required document elements and a plurality of optional document elements. The required document elements may be defined as a set of at least one document element that must be completed before the structured document may be generated as specified by the DTD. The optional document elements may be defined as a set of at least one document element that the user may choose to add to the edit interface as specified by the DTD. The EIG may utilize the DTD memory model to generate an edit interface containing the required document elements and an embedded copy of the DTD from the selected SDT.

The DTD memory model and the edit interface may be forwarded to a UIE of the DAS. The UIE may be configured to utilize the DTD memory model to provide a graphical user interface for the user to modify (add or delete information) a generated edit interface. The graphical use interface may display the required and/or optional document elements as icons for a user to “drag-and-drop” into the generated edit interface. The UIE may further be configured to provide the user with the capability of viewing the generated edit interface utilizing a Web browser. The user may be required to input information into the required document elements.

The UIE may be further configured to forward the resulting edit interface after modification to an OSDG of the DAS in response to a command of the user. The OSDG may be configured to receive a modified edit interface from the UIE and generate an OSD from the modified edit interface. During the generation process, the OSDG may be further configured to check the OSD against the DTD memory model to ensure that the rules for the DTD of the selected template are in compliance. If the modified edit interface does not conform with the DTD of the selected template, the OSDG may be configured to return the modified edit interface to the UIE for the user to correct. Otherwise, the OSDG may be configured to output the OSD to a user designated location or device.

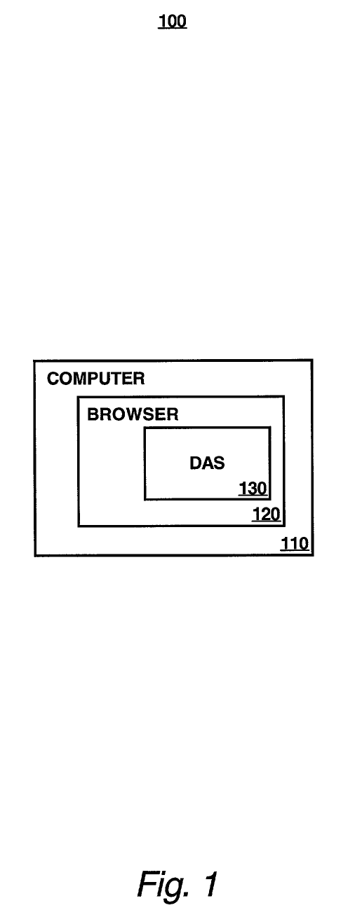

FIG. 1 illustrates a block diagram of an exemplary computer system 100 in which an embodiment of the present invention may be implemented. As shown in FIG. 1, the computer system 100 includes at least a computer 110, a Web browser 120, and a DAS 130. The computer 110 may be configured to serve as an execution platform for the browser 120. The computer 110 may be implemented by a personal computer, a laptop, a workstation, and the like.

The Web browser 120 may be configured to provide the capability to display information from a network for a user as known to those skilled in the art. The Web browser 120 may be further configured to provide a virtual machine execution platform for the DAS 130. A virtual machine may be defined as a self-contained operating environment that behaves as a separate computer.

The DAS 130 may be configured to generate an OSD from a user-selected template, and the OSD may be stored in a user-specified location and/or device. When selecting the template, the user may choose from templates available to the computer 110 or a subset of templates available to the system 100. For example, a user may be given access to a limited number of templates associated with the user's occupation or position. A DTD embedded within each template may provide the “rules” or structure for the OSD. When a user selects a template, the DAS may provide a graphical user interface based on the embedded DTD for a user to enter information. The embedded DTD may provide the required document elements for the OSD that may eventually be filled with information. Furthermore, the embedded DTD may provide a number of optional documents elements that may be added by the user to customize the OSD.

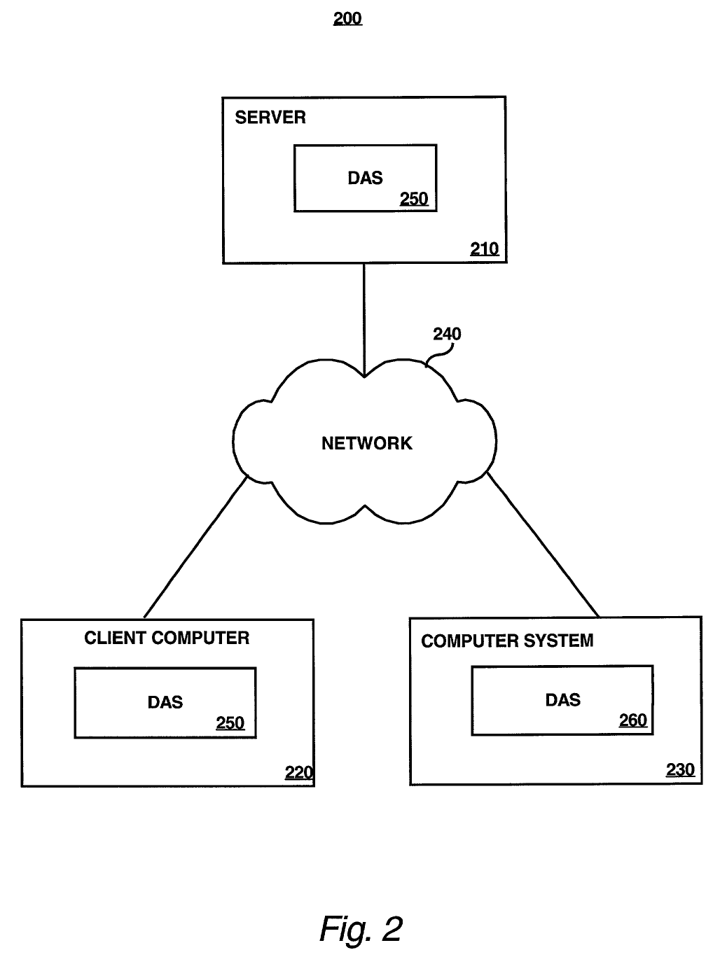

FIG. 2 illustrates a block diagram of an exemplary computer network 200 in which an embodiment of the present invention may be implemented. As shown in FIG. 2, the computer network 200 includes at least a server 210, a client computer 220 and a computer system 230. The server 210 may be interfaced with the client computer 220 and the computer system 230 through a network 240. The server 210 may be configured to provide computing services, (i.e., application software, data storage, input/output service, etc.), to the client computer 220 and the computer system 230. The client computer 220 may be configured to provide a user with access to the computing services of the server 210 at a remote location. The client computer 220 may be implemented as a terminal, a personal computer, a workstation, and the like. The computer system 230 may be configured to execute the functionality of the DAS 260. The DAS 260 may be configured to augment the functionality of the computer system 230 with the resources of the server 210, (e.g., the DAS 260 may store an OSD on the server 210). The computer system 230 may be implemented as a personal computer, a workstation, and the like.

The network 240 may be configured to provide a communication channel between the server 210, the client computer 220, and the computer system 230. The network 240 may be implemented as a local area network, a wide area network, a wireless network, and the like.

The computer network 200 may also include two versions of the DAS 130, a network DAS 250 and a standalone DAS 260. Although the present invention contemplates two versions of the DAS 130, each version of the DAS, 250 and 260, may incorporate the functionality of the DAS 130. The standalone DAS 260 may be configured to execute the functionality of the DAS 130 in the computer system 230.

The network DAS 250 may be configured to execute between the server 210 and the client computer 220. The functionality of the network DAS 250 may be configured to be distributed between the server 210 and the client computer 220. For example, the DAS 250 operating on a server 210 may provide some or all of the DAS 250 functionality in the form of web browser applets and file storage for the operation of DAS 250 on a client computer 220. It is known in the art to divide the functionality between server and client based on application and system configuration requirements.

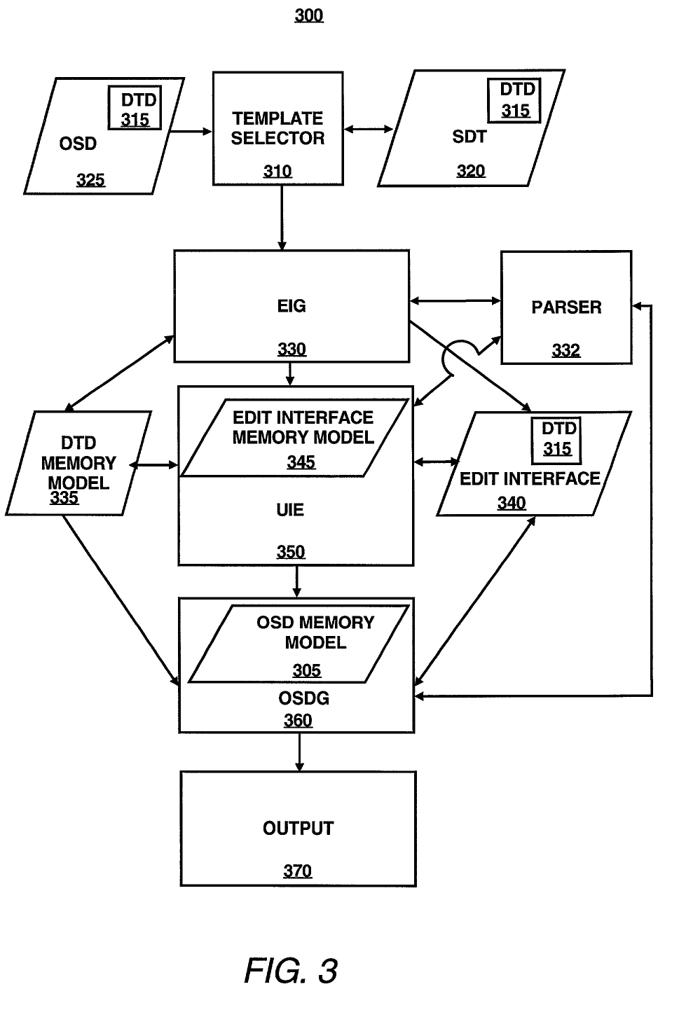

FIG. 3 illustrates a block diagram of an exemplary embodiment of a software architecture 300 for the DAS 130 shown in FIG. 1. The software architecture 300 includes at least a template selector 310, an EIG 330, a parser 332, a DTD memory model 335, an edit interface 340, a UIE 350, an OSDG 360, and an output 370.

The template selector 310 of the DAS 130 may be configured to provide a selection of templates for a user to select a template. The selection of templates may be from a plurality of SDTs 320 or a plurality of existing OSDs 325. The SDTs 320 and/or OSDs 325 may be presented to a user in a graphical user interface manner, (e.g., a dialog box, a list, etc.), as known to those skilled in the art. The template selector 310 may be further configured to forward the selected template to the EIG 330.

The selected template may contain an embedded DTD 315. The DTD 315 may be defined as rules or grammar of a structured document. The DTD 315 may specify the possible types of document elements, the possible placement of the document elements, the possible order of document elements, etc., that may exist within a structured document. The DTD 315 may further specify the attributes (e.g., font type, font size, line spacing, etc.), the required document elements, the optional document elements, and the like.

The EIG 330 may be configured to extract the embedded DTD 315 in response to the selection of a template from the template selector 310. The EIG 330 may be further configured to utilize the parser 332 to parse the DTD 315 to generate a DTD memory model 335, (i.e., a hierarchical representation of the structure of document elements). The DTD memory model 335 may be stored in a temporary allocated memory location as a file accessible to the UIE 350 and the OSDG 360.

The EIG 330 may be further configured to retrieve the required document elements from the DTD memory model 335 to generate an edit interface memory model 345 and embed, (i.e., incorporate in a non-modifiable manner), the DTD 315 within the edit interface 340. The edit interface memory model 345 may be then utilized by the EIG 330 to generate the edit interface 340. The EIG 330 may be further configured to embed the DTD 315 within the edit interface 340.

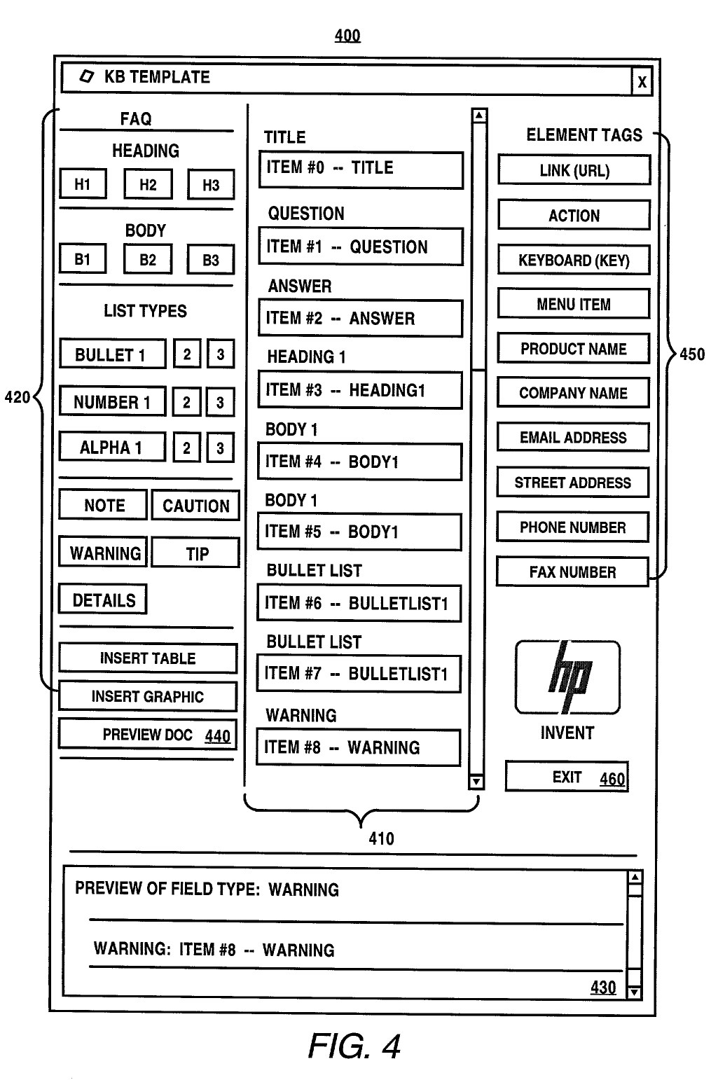

The UIE 350 may be configured to utilize the edit interface 340 and the DTD memory model 335 to display the edit interface 340 and provide a user with the capability of entering information, (i.e., text, graphic, and the like, and/or modifying the edit interface 340). The UE 350 may be further configured to be a graphical user interface, for example, as shown in FIG. 4 and described below, for the user to interact with the required document elements, optional document elements, fields of information entry, etc. The edit interface 340 may have required document elements, (e.g., a title element, a chapter element, and a question/answer element), that require the user to input information to match the corresponding required document element. Moreover, the edit interface 340 may be modified according to the rules of the DTD memory model 355 to include additional document elements, (i.e., optional document elements). The additional document elements may be a set of document elements specified by the DTD memory model 335.

In response to a user request to generate an OSD, the UIE 350 may be further configured to utilize the parser 332 to parse through the modified edit interface 340 to test for the existence of context specific (e.g., character information in document elements expecting text and graphical information in document elements expecting graphics) information in all of the document elements currently within the edit interface 340. These current document elements may represent the required document elements and any optional document elements that the user may have added. If the test fails, the UIE 350 may be further configured to return the user to the UE 350 to complete the modification of the document elements currently within the edit interface 340. Otherwise, the UIE 350 may forward the modified edit interface 340 to the OSDG 360.

The OSDG 360 may be configured to utilize the parser 332 to parse the modified edit interface 340 to derive an OSD memory model 365 conforming to mark-up language code format and store the OSD memory model 365 in a temporary allocated memory location for access by the OSDG 360. The OSD memory model 365 may contain at least the document elements from the modified edit interface 340 and the DTD 315. To test for compliance of the OSD memory model 365 with the DTD 315 of the template selected in the template selector 310, the OSDG 360 may be further configured to compare the document element hierarchal structure of the OSD memory model 365 with the document element hierarchal structure of the DTD memory model 335. If the test fails, the DAS 130 may be configured to return the user to the UIE 350 with the edit interface 340 to correct the non-compliance. Otherwise, the DAS 130 may be configured to forward the OSD memory model 365 to the output 370. The output 370 may be configured to store the OSD memory model 365 as an OSD in an output location. The output location may comprise a printer, a local file system, a remote file system, a structured document database, a structured document management system, and the like.

FIG. 4 is an exemplary screen shot of an embodiment of an edit user interface of the UIE 350. As shown in FIG. 4, the UIE 350 may include at least a plurality of document element dialog boxes 410, a plurality of optional document element icons 420, a document element preview window 430, a document preview icon 440, a plurality of element tag icons 450 and an exit icon 460.

The document element dialog boxes 410 may be configured to display the current document elements in the edit interface 340. Accordingly, a user may select a document element in the edit interface 340 and edit information within a selected document element. Initially, an edit interface 340 may display only required document elements. Subsequently, any document elements dragged and dropped from the optional document element icons 420 may be displayed in the edit interface 340 along with the required document elements.

The plurality of optional document element icons 420 may include the plurality of optional document elements as defined by the DTD memory model 335. The UIE 350 may be further configured to provide the user with the capability of adding the selected optional document element by a ‘drag and drop’ method to the document element dialog boxes 410. The UE 350 may be further configured to compare the user's placement of the selected optional document element to the DTD memory model 335 to ensure the user's placement is compliant with the DTD 315. The UIE 350 may be further configured to modify the plurality of optional document element icons 420 in response to the user ‘pointing’ to a location within the document element dialog boxes 410 based on the DTD memory model 335. For example, a subset of the plurality of optional document element icons 420 may be displayed by the UIE 350 as selectable when a user ‘point’ to one location within the document element dialog boxes 410 and may be displayed by the UIE 350 as non-selectable when a user ‘point’ to another location within the document element dialog boxes 410 The UIE 350 may be configured to utilize the document element preview window 430 to display the current document element selected for editing as it may appear in an OSD. The UIE 350 may also be configured to provide the user with the capability of previewing, in a Web browser, the OSD in progress by selecting the document preview icon 440.

The UIE 350 may be configured to provide the user with the capability of assigning an element tag 450, as defined by the DTD memory model 335, to a selected object. An element tag may be defined as a demarcation of a functional object within a mark-up language compliant document when viewed with a Web browser. The functionality may include displaying a linked product Web page, initiating an email, demarcating a street address or phone number, etc. The object may include a product, an email address, a street address or phone number, etc. respectively. The object may be in the form of text manually entered or a selected link from another application, (i.e., a Web browser).

The UIE 350 may be configured to provide the user with the capability of initiating the forwarding of the edit interface 340 to the OSDG 360 by selecting the exit icon 460.

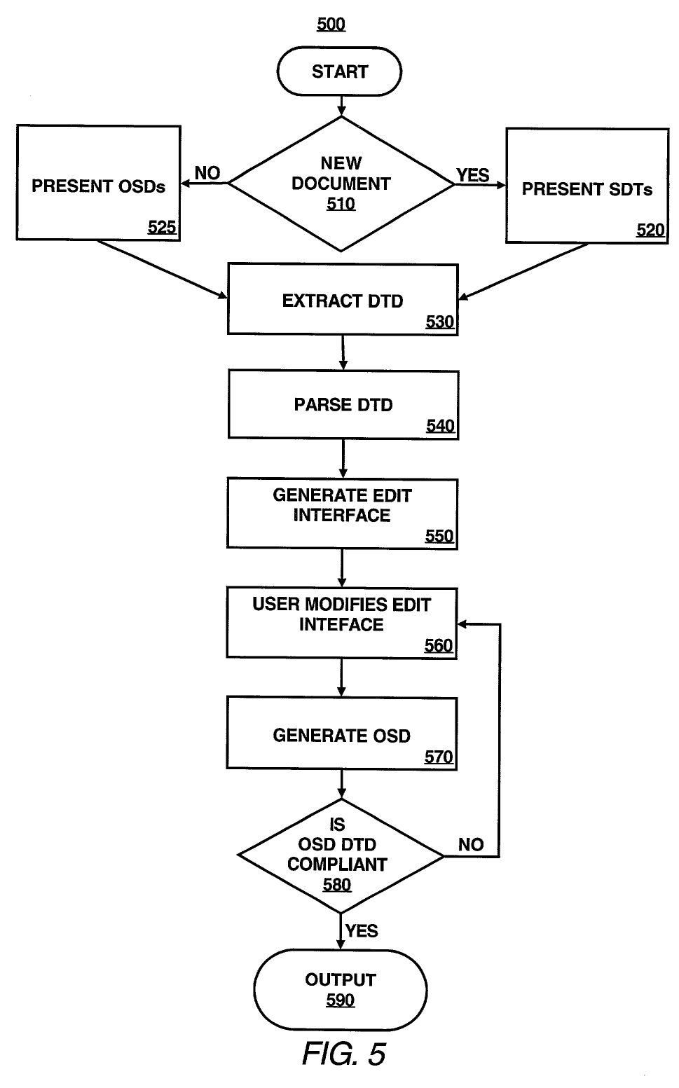

FIG. 5 shows a flow diagram of an exemplary method 500 for implementing the principles of the software architecture 300 shown in FIG. 3. In step 510, the DAS 130 presents a user with a choice of generating a new structured document in response to initiating the DAS 130. If the user decides to create a new structured document, the DAS 130 may be configured to present the user with the SDTs 320 in step 520. The SDTs 320 may, for example, be presented to the user in a dialog box. The dialog box may display each SDT 320 with a corresponding selection box for the user to select the desired SDT 320.

If the user chooses not to create a new document in step 510, the DAS 130 presents the user with the OSDs 325 in step 525. The OSDs 325 may, for example, be presented to the user in a list box listing the previously stored OSDs 325 for the user to select the desired OSD 325. The list box may include the capability to browse a document management storage system to search for and select from additional previously stored OSDs 325.

In step 530, the DAS 130 extracts the embedded DTD 315 from either the SDT 320 or the OSD 325. In step 540, the DAS 130 utilizes the parser 332 to parse the DTD 315 and generate a DTD memory model 335 from the extracted DTD 315, as shown in FIG. 3.

In step 550, the edit interface 340 template is generated from the DTD memory model 335 by the EIG 330. For example, the EIG 330 may utilize the parser 332 to parse the required document elements from the DTD memory model 335. The EIG 330 further stores the required document elements with the embedded DTD 315 to generate the edit interface 340. If the EIG 330 received an OSD 525 the EIG 330 further utilizes any optional document elements from the OSD 525 to modify the structure of the edit interface 340 and the EIG 330 further utilizes the information from the OSD 525 to modify the required document elements and any optional documents of the edit interface 340.

In step 560, a user modifies the edit interface 340 and requests generation of an OSD based on the modified edit interface 340. To facilitate the modification of the edit interface 340, the UIE 350 may utilize the edit interface 340 and the DTD memory model 335 to generate a graphical user interface for the user to interact with the required document elements, optional document elements, fields of information entry, etc. To facilitate the user request to generate an OSD based on the modified edit interface 340, the UIE 350 may provide a selectable exit icon 460.

In step 570 the OSD memory model 365 is generated by the OSDG 360. For example, the OSDG 360 may utilize the parser 332 to parse the edit interface 340 to generate the OSD memory model.

In step 580, the OSDG 360 checks for compliance of the OSD memory model 365 with the DTD 315 by comparing the OSD memory model 365 to the DTD memory model 335. For example, the OSDG 360 may utilize the parser 332 to step from one document element to the next in the OSD memory model 365. The document elements form ‘branches’ in the hierarchical structure, (e.g., in a question and answer type document, an answer document element may ‘branch’ off of a question document element). Upon identifying a ‘branch’ in the structure of the OSD memory model 365, the OSDG 360 utilizes the parser 332 to locate an identical branching structure in the DTD memory model 335 as identified in the OSD memory model 365. If the OSDG 360 determines the OSD memory model 365 is compliant with the DTD memory model 335, the OSD memory model 365 is output in the output step 590. If the OSDG 360 determines the OSD memory model 365 is not compliant with the DTD memory model 335, the OSDG 360 notifies the user of the non-compliance and the edit interface 340 can be further modified in step 560.

In step 590, the OSD memory model 365 is stored as an OSD to a user specified output location. The output location may comprise a printer, a local file system, a remote file system, a structured document database, a structured document management system, and the like.

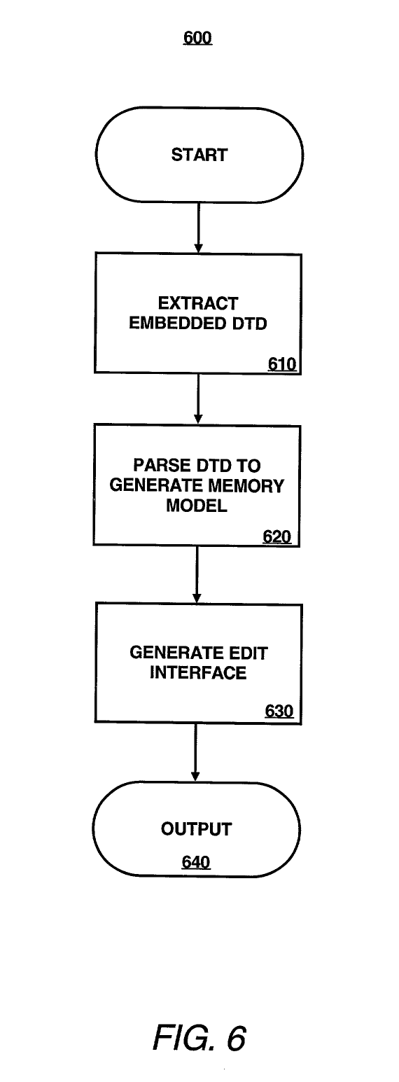

FIG. 6 illustrates a flow diagram of an exemplary method 600 implementing the principles of the software architecture of the EIG 330, as shown in FIG. 3. In step 610, the EIG 330 extracts the DTD 315 from a selected template containing the DTD 315 embedded therein and utilizes the DTD 315 to generate the edit interface 340. For example, the EIG 330 receives a template containing an embedded DTD 315, and the template may be in the form of a SDT 320 or an OSD 325. The EIG 330 may further utilize the parser 332 to parse the template and determine the limits of the DTD 315 (i.e., determine the beginning and end of the DTD 315) embedded within the template. The EIG 330 further extracts the identified DTD 315.

In step 620, the EIG 330 receives the DTD 315, and the EIG 330 may further utilize the parser 332 to parse the DTD 315 into a hierarchical representation of the structure of document elements based on the DTD 315. The EIG 330 may further store, in a temporary allocated memory location accessible to the UIE 330 and the OSDG 360, a DTD memory model 335 containing at least a hierarchical representation of the structure of document elements of the DTD 315. Also, the EIG 330 may further provide the EIG 330 with access to the DTD 315.

In step 630, the EIG 330 may generate the edit interface 340. For example, the EIG 330 may receive the DTD memory model 335 and accesses the DTD 315. The EIG 330 may further utilize the parser 332 to parse the required document elements from the DTD memory model 335. The EIG 330 may further embed, (i.e., incorporates in a non-modifiable manner), the DTD 315 within the required document elements, thus generating an edit interface 340, as shown in FIG. 3. The DTD 315 may be configured to be incorporated into the edit interface 340 in a static, or nonmodifiable, manner.

In step 640, the EIG 330 may receive the edit interface 340 and outputs the edit interface 340 to the UE 350.

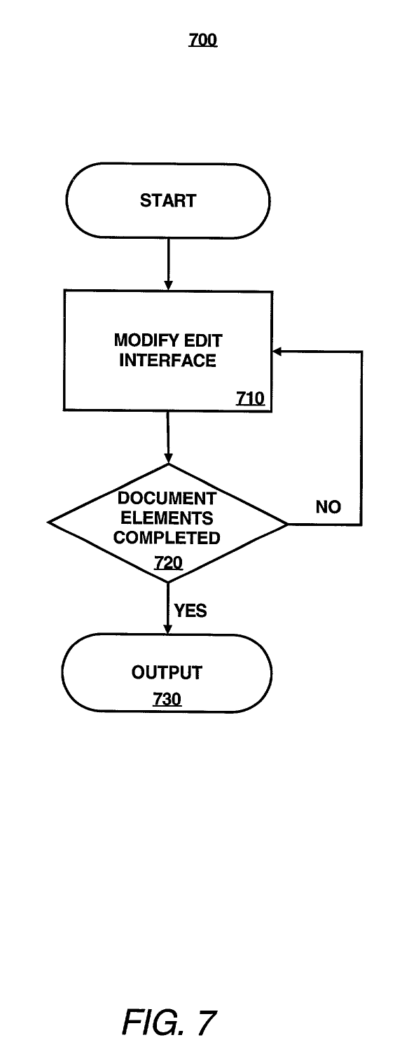

FIG. 7 illustrates a flowchart of an exemplary method 700 for implementing the principles of the software architecture of the UE 350, shown in FIG. 3. In step 710, the UIE 350 may modify the edit interface 340 based on user inputs and output the modified edit interface 340 to the OSDG 360 at the request of the user. For example, the UIE 350 receives the DTD memory model 335 and the edit interface 340 from the EIG 330. The UIE 350 further utilizes the DTD memory model 335 and the edit interface 340 to display the edit interface 340 in a graphical user interface, as discussed above with respect to the description of FIG. 4.

The UIE 350 may further provide a graphical environment for the user to, according to the DTD memory model 335, add optional document elements to the edit interface 340. Optional document elements may be added to the edit interface 340 by “dragging and dropping” an optional document element from the plurality of optional document element icons 420 into the desired location within the document element dialog boxes 410 as shown in FIG. 4. The UIE 350 may further provide a graphical environment for the user to, according to the DTD memory model 335, remove optional document elements from the edit interface 340. The UIE 350 may further determine if, according to the DTD memory model 335, optional document elements selected to be removed by the user may be deleted. For example, an optional document element having one or more optional documents elements dependent upon it may not be deleted according to the DTD memory model 335 without deleting the one or more dependent optional elements beforehand.

The UE 350 may further provide a graphical environment for the user to edit text within a selected textual document element of the edit interface 340. The text information may comprise text directly typed in by the user and text selected from an existing document. The UIE 350 may further provide a graphical environment for the user to add a graphical information location to a selected graphical document element of the edit interface 340. The graphical information location may comprise a UNC location entered by the user, a graphic information location selected by utilizing an existing file system browse and select function, graphical information “cut and pasted” from an application, and a graphic information location of a graphic “dragged and dropped” from an application. The UIE 350 may further provide a graphical environment for the user to edit optional elements of the edit interface 340. The UIE 350 further utilizes the DTD memory model 335, as shown in FIG. 3, to determine the optional document elements that may be edited by the user.

The UIE 350 may further provide the user with the capability to apply a plurality of styles, as allowed by the DTD memory model 335, to the edit interface 340 and further to provide the user with the capability of utilizing a defined style to preview, on a Web browser or the like, an OSD corresponding to the edit interface 340 by selecting a document preview icon 440. The UIE 350 may further provide the user with a selectable exit icon 460 to provide the user with the capability of requesting the modified edit interface 340 be utilized to generate an OSD.

In step 720, the UIE 350 receives the edit interface 340 in response to the user request and determines if information consistent with the document element type (e.g., character type data present in a document element expecting text and graphic information location present in a document element expecting a graphic) has been completed (e.g., input by a user for all the document elements present in the edit interface 340). For example, the UIE 350 may utilize the parser 332 to find all document elements within the edit interface 340 by parsing the edit interface 340. The UIE 350 further determines information is inconsistent with the document element type present in each document element, the UIE 350 informs the user of the missing information and the edit interface 340 may be further modified in step 710. If the UIE 350 determines that information consistent with the document element type is present, the modified edit interface 340 is output in step 730. For example, in step 730, the UIE 350 receives the modified edit interface 340 and forward the modified edit interface 340 to the OSDG 360 of the DAS 130.

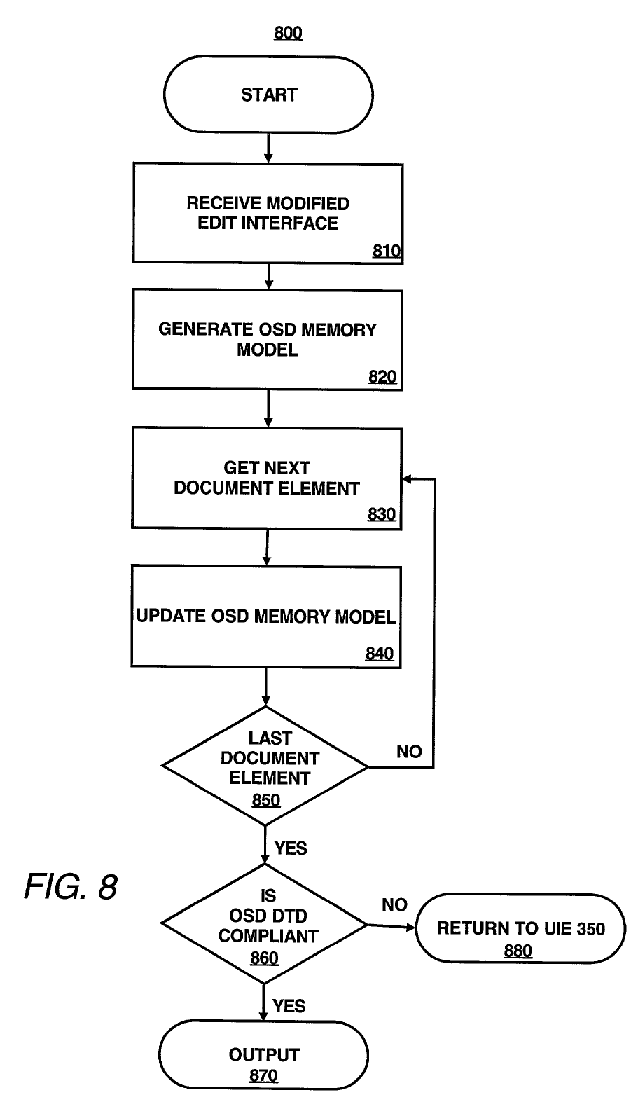

FIG. 8 illustrates a flowchart of the method 800 for the OSDG 360 of the DAS 130 shown in FIG. 3. The OSDG 360 generates the OSD from the modified edit interface 340.

In step 810, the OSDG 360 receives the modified edit interface 340 from the UIE 350 and further stores the modified edit interface 340 in a temporary allocated memory location accessible to the OSDG 360.

In step 820, the OSDG 360 utilizes the modified edit interface 340 to generate an OSD memory model 365 conforming to mark-up code language format (e.g., SGML, HTML, XML, etc.) and containing the embedded DTD 315. For example, the OSDG 360 utilizes the parser 332 to identify the limits of the embedded DTD 315 from the modified edit interface 340 by parsing the modified edit interface 340. The OSDG 360 further stores a file conforming to mark-up code language format (e.g., SGML, HTML, XML, etc.) and embeds the identified DTD 315 therein, thus generating the OSD memory model 365. The OSDG 360 further stores the OSD memory model 365 in a temporary allocated memory location accessible to the OSDG 360 and the output 370.

In step 830, the OSDG 360 utilizes the modified edit interface 340, provided by step 810, to retrieve the next document element. For example, the OSDG 360 utilizes the parser 332 to determine the limits of the next document element of the modified edit interface 340. The OSDG 360 further copies the identified next document element from the modified edit interface 340.

In step 840, the OSDG 360 updates the OSD memory module 365. For example, the OSDG 360 further receives the identified next document element and appends this information into the OSD memory model 365.

In step 850, the OSDG 360 determines if the most recent document element appended to the OSD memory model 365 is the last document element in the modified edit interface 340. For example, the OSDG 360 utilizes the parser 332 to determine if the parser 332 has reached an end of file (“EOF”) marker in the modified edit interface 340. If the parser 332 has not reached the EOF marker, the OSDG 360 retreives the next document element from the modified edit interface 340 in step 830. If the EOF marker is reached, the OSDG 360 further determines if OSD memory model 365 is compliant with the DTD memory model 335 (step 860).

In step 860, the OSDG 360 determines if the OSD memory model 365 is compliant with the DTD memory model 335. For example, the OSDG 360 may utilize the parser 332 to step from one document element to the next in the OSD memory model 365. The document elements form ‘branches’ in the hierarchical structure e.g., in a question and answer type document, an answer document element may ‘branch’ off of a question document element. Upon identifying a branch in the structure of the OSD memory model 365, the OSDG 360 may utilize the parser 332 to locate an identical branching structure in the DTD memory model 335 as identified in the OSD memory model 365. If the OSDG 360 further determines that the OSD memory model 365 is compliant, the OSD memory model 365 is outputted as the OSD in step 870.

In step 870, the OSDG 360 receives the OSD memory model 365 and stores the OSD memory model 365 as the OSD in a user specified output location. The output location may comprise a printer, a local file system, a remote file system, a structured document database, a structured document management system, and the like.

In step 880, the OSDG 360 notifies the user of the non-compliance and the modified edit interface may be further modified in the UIE 350.

The present invention may be performed as a computer program. The computer program may exist in a variety of forms both active and inactive. For example, the computer program can exist as software program(s) comprised of program instructions in source code, object code, executable code or other formats; firmware program(s); or hardware description language (HDL) files. Any of the above can be embodied on a computer readable medium, which include storage devices and signals, in compressed or uncompressed form. Exemplary computer readable storage devices include conventional computer system RAM (random access memory), ROM (read only memory), EPROM (erasable, programmable ROM), EEPROM (electrically erasable, programmable ROM), and magnetic or optical disks or tapes. Exemplary computer readable signals, whether modulated using a carrier or not, are signals that a computer system hosting or running the DAS 130 can be configured to access, including signals downloaded through the Internet or other networks. Concrete examples of the foregoing include distribution of executable software program(s) of the computer program on a CD ROM or via Internet download. In a sense, the Internet itself, as an abstract entity, is a computer readable medium. The same is true of computer networks in general.

While the invention has been described with reference to the exemplary embodiments thereof, those skilled in the art will be able to make various modifications to the described embodiments of the invention without departing from the true spirit and scope of the invention. The terms and descriptions used herein are set forth by way of illustration only and are not meant as limitations. In particular, although the method of the present invention has been described by examples, the steps of the method may be performed in a different order than illustrated or simultaneously. Those skilled in the art will recognize that these and other variations are possible within the spirit and scope of the invention as defined in the following claims and their equivalents.

What is claimed is:

1. A method of generating a structured document, said method comprising:
generating an edit interface in response to a selection of a structured document template from a plurality of structured document templates;
displaying said edit interface and a plurality of document elements associated with said edit interface;
modifying said edit interface by dragging and dropping a selected document element of said plurality of document elements; and
generating an output structured document from said edit interface in response to a generation command:

2. The method according to claim 1, wherein said method of generating a structured document further comprises:
providing a template selection user interface including a dialog box, a folder, and a pull down menu, wherein said template selection user interface is configured to select said one structured document template from said plurality of structured document templates.

3. The method according to claim 1, wherein said step of providing a template selection user interface further comprising:
providing a plurality of existing output structured documents by said template selection user interface; and
selecting an existing output structured document from said plurality of existing output structured documents.

4. The method according to claim 3, wherein said step of generating said edit interface further comprises:
generating said edit interface from a selected existing output structured document, wherein said edit interface includes user-input data previously stored with said existing output structured document.

5. The method according to claim 1, wherein each of said plurality of structured document templates includes a document type definition.

6. The method according to claim 5, wherein said step of generating an edit interface further comprising:
utilizing a corresponding document type definition for said selected structured document template to generate a memory model;
parsing said memory model for a plurality of required document elements;
generating said edit interface including said plurality of required document elements, each said document element requiring an input of information; and
outputting said generated edit interface to a user interface editor.

7. The method according to claim 6, wherein said step of generating said edit interface further comprises:
embedding said corresponding document type definition of said selected one structured document template within said edit interface.

8. The method according to claim 7, wherein said step of modifying said edit interface further comprises:
receiving user-input modification data;
determining a compliance of said user-input modification data with said memory model; and
modifying said edit interface with said user-input modification data in response to said compliance of said user-input modification data.

9. The method according to claim 8, further comprising:
receiving user-input document element information for said plurality of required document elements and said selection of one or more optional document elements;
determining receipt of user-input document element information for each of said plurality of required document elements and said each selected optional document element in response to receiving a user generation request; and
generating an output structured document memory model utilizing said user-input document element information for each of said plurality of required document elements and for each said selected optional document element.

10. The method according to claim 9, wherein said step of generating said output structured document further comprising:
determining compliance of said generated output structured document memory model with said memory model; and
generating said output structured document in response to said generated output structured document memory model in compliance with said document type definition memory model.

11. The method according to claim 10, further comprises:
outputting said output structured document, said outputting including one of printing said output structured document, storing said output structured document to a local directory, storing said output structured document to a remote directory, and storing said output structured document to a document management service.

12. A document authoring system comprising:
an edit interface generator configured to generate an edit interface in response to receiving a structured document template;
a user interface editor configured to modify said edit interface by dragging and dropping a selected document element from a plurality of document elements and to modify said edit interface by entering user-input modification data, wherein said user interface editor is further configured to generate a modified edit interface in response to completion of selection of said plurality of document elements and said user-input modification data; and
an output structured document generator configured to receive said modified edit interface, said output structured document generator being further configured to generate a structured document based on said modified edit interface, and to output said structured document, wherein said output includes one of printing said structured document, storing said structured document to a local directory, a remote directory, and storing said structured document to a document management service.

13. The document authoring system according to claim 12, further comprising:
a plurality of structured document templates, wherein each of said plurality of structured document templates includes a document type definition; and
a template selection user interface configured to provide said structured document template used to generate said edit interface from said plurality of structured document templates.

14. The document authoring system according to claim 13, further comprising:
a parser configured to extract said document type definition from said structured document template, wherein said edit interface generator is further configured to generate a document type definition memory model from said extracted document type definition.

15. The document authoring system according to claim 14, wherein said parser is configured to identify a plurality of required document elements from said document type definition memory model, said edit interface generator is further configured to generate said edit interface from both said identified plurality of required document elements and said extracted document type definition.

16. The document authoring system according to claim 15, further comprising:
a graphical user interface configured to receive said user-input modification data, said user interface editor is further configured to modify said edit interface based on said user-input modification data.

17. The document authoring system according to claim 16, wherein said user-input modification data including one of user-input document element information for said plurality of required document elements, a selection of one or more optional documents included in said document type definition memory model, and user-input document element information for said selection of one or more optional documents.

18. A program storage device or signals readable by a computer, tangibly embodying instructions executable by said computer to perform a method for enabling a user to generate a structured document capable of being printed, stored to a local directory, stored to a remote directory, and stored to a document management service, said generation comprising:
generating an edit interface in response to a selection of a structured document template from a plurality of structured document templates;
displaying said edit interface and a plurality of document elements associated with said edit interface;
modifying said edit interface by dragging and dropping a selected document element of said plurality of document elements; and
generating an output structured document from said edit interface in response to a generation command.

19. A method for generating an edit interface, said method comprising:
generating a document type definition memory model based on document elements parsed from a corresponding document type definition;
generating an edit interface memory model based on said document type definition memory model;
embedding said document type definition within said edit interface memory model, wherein an output structured document generated from said user interface memory model is configured to be edited; and
outputting an edit interface based on said edit interface memory model.

20. A method for generating an edit user interface, said method comprising:
parsing a document type definition memory model for a plurality of required document elements, a plurality of optional elements, and a plurality of element tags;
displaying said plurality of required document elements, each required document element being displayed in a corresponding document element dialog box in said edit interface;
displaying said plurality of optional document elements, each optional document element being displayed as a corresponding document element icon in said edit interface; and
displaying said plurality of element tags, each element tag being displayed as a corresponding element tag icon in said edit interface.
